(19) United States
(12) Patent Application Publication
(10) Pub. No.: US 2003/0065494 A1
(43) Pub. Date: Apr. 3, 2003

(54) Apparatus and methods for characterizing and creating electronic circuitry

(76) Inventor: John F. Croix, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/263,467

(22) Filed: Oct. 2, 2002

Related U.S. Application Data
(63) Continuation-in-part of application No. 09/963,885, filed on Sep. 26, 2001.
Application No. 09/963,885 is a continuation of application No. 09/090,457, filed on Jun. 4, 1998, now Pat. No. 6,327,557.

(51) Int. Cl. G06F 17/10

(52) U.S. Cl. 703/2

(57) ABSTRACT

According to a first model of an operation of circuitry, a first set of estimates of the operation is generated in response to a set of conditions, including a first estimate of the operation in response to a first condition. According to a second model of the operation, a second set of estimates of the operation is generated in response to the first condition and the first set. The second model includes a series expansion characteristic equation. In response to a comparison between the first estimate and the second set, a subset of the first set is selected. According to the second model, an estimate of the operation is generated in response to a second condition and the selected subset.

### CROSS-REFERENCE TO RELATED APPLICATIONS

This patent application is a continuation-in-part of U.S. patent application Ser. No. 09/963,885, Attorney Docket No. SIME:010C1, filed on Sep. 26, 2001. This patent application is a continuation-in-part of U.S. patent application Ser. No. 09/963,885, Attorney Docket No. SIME:010C1, filed on Sep. 26, 2001, which is a continuation of U.S. patent application Ser. No. 09/090,457, filed on Jun. 4, 1998, now U.S. Pat. No. 6,327,557.

### TECHNICAL FIELD

This patent application relates in general to electronic circuitry and, in particular, to methods and apparatus for characterizing and creating electronic circuitry.

### BACKGROUND

Increasing density, complexity and speed of integrated electronic circuitry has resulted in a need for higher accuracy tools that support creation of designs for such circuitry, along with a need for higher speed tools to accommodate restricted schedules for creating such designs. One type of tool is a characterization tool for characterizing various cells of the circuitry. A cell is, for example, a component that performs a logical operation within the circuitry.

A characterization tool outputs characterization information that describes a cell's operations in response to various conditions. In response to such characterization information, a human designer may predict whether the circuitry will meet performance requirements. If such characterization information is inaccurate, the designer's prediction may likewise be inaccurate. If a design is manufactured based upon an inaccurate prediction, significant wasted time and monetary expense may be incurred.

SPICE is a generic name of a tool that includes a software program for modeling, in a relatively accurate manner, operations of cells in response to specified conditions. To achieve such accuracy, SPICE consumes a relatively high level of computational resources. Accordingly, execution of SPICE may result in substantial time delays.

In view of such delays, practical limits are imposed on the extent to which a human designer may rely upon SPICE for modeling a cell's operations in response to a wide variety of conditions. Rather than using SPICE for modeling a cell's operations in response to all likely conditions, a previous technique relies upon the designer to specify a number of representative conditions. According to such a technique, SPICE is executed for modeling the cell's operations in response only to the specified conditions.

A different tool, which is less computationally-intensive than SPICE, is executed for modeling the cell's operations in response to other conditions, thereby conserving computational resources and time. Nevertheless, unless the designer already knows the expected operations of the cell in response to various conditions, it is difficult and, in some cases, impractical for the designer to accurately determine which conditions should be specified as being the most representative. Accordingly, a cell's operations as estimated by the different tool may deviate by more than two percent (2%), typically about 10%, from the cell's operation as estimated by SPICE. For conditions distant from the specified conditions, the deviations between SPICE estimates and the different tool's estimates may reach ten percent (10%) or more, typically about 25%.

Accordingly, a need has arisen for a method and system for creating electronic circuitry, in which cells of the circuitry are characterized with higher accuracy relative to previous techniques. Also, a need has arisen for a method and system for creating electronic circuitry, in which cells of the circuitry are characterized with higher speed relative to previous techniques.

### SUMMARY

This invention relates to creating and characterizing electrical circuitry. One aspect of the invention concerns a system for characterizing electrical circuitry. In an exemplary embodiment, the system includes a computer for circuit characterization. According to a first model of operation of the circuitry, the computer generates a first set of estimates of the operation in response to a set of conditions, including a first estimate of the operation in response to a first condition. Furthermore, according to a second model of the operation of the circuitry, the computer generates a second set of estimates of the operation in response to the first condition and the first set. The second model of the operation includes a series expansion characteristic equation. In response to a comparison in response to a comparison between the first estimate and the second set, the computer selects a subset of the first set. Using the second model, the computer generates an estimate of the operation of the circuitry in response to a second condition and the selected subset.

Another aspect of the invention relates to methods of characterizing electrical circuitry. In one exemplary embodiment of the invention, with a first computer-implemented operation model of the circuitry, a method according to the invention includes generating a first set of estimates of the operation in response to a set of conditions, including a first estimate of the operation in response to a first condition. With a second computer-implemented model of the operation of the circuitry, the method further comprises generating a second set of estimates of the operation in response to the first condition and the first set, wherein the second model of the operation comprises a series expansion characteristic equation. In response to a comparison between the first estimate and the second set, the method selects a subset of the first set. With the second computer-implemented model, the method also includes generating an estimate of the operation in response to a second condition and the selected subset.

A further aspect of the invention concerns computer program products. In one exemplary embodiment, a computer program product includes a computer application that is processable by computer, and apparatus from which the computer application is accessible by the computer. According to a first model of an operation of circuitry, the computer application causes the computer to generate a first set of estimates of the operation of an electrical circuitry in response to a set of conditions, including a first estimate of the operation in response to a first condition. Furthermore, according to a second model of the operation, the computer application causes the computer to generate a second set of estimates of the operation in response to the first condition and the first set. The second model of the operation of the circuitry comprises a series expansion characteristic equation. The computer application causes the computer to select a subset of the first set in response to a comparison between the first estimate and the second set. According to the second model, the computer application causes the computer to generate an estimate of the operation in response to a second condition and the selected subset.

### BRIEF DESCRIPTION OF THE DRAWINGS

Exemplary and illustrative embodiments and their advantages are better understood by referring to the following descriptions and accompanying drawing, in which:

FIG. 1 is a block diagram of a system for processing information according to an illustrative embodiment according to the invention;

FIG. 2 is a graph of an example curve for illustrating a concept of an illustrative embodiment according to the invention;

FIG. 3 is a schematic electrical circuit diagram of a 3-input NAND gate for illustrating a concept of an illustrative embodiment according to the invention;

FIG. 4 is a graph of voltages at nodes of the NAND gate of FIG. 3, as a function of time;

FIG. 5 is a schematic electrical circuit diagram of a driving cell and a characterized cell;

FIG. 6 is a schematic electrical circuit diagram of a modified version of the circuitry of FIG. 5;

FIG. 7 is first graph of response time r as a function of Cₗ and tᵣ;

FIG. 8 is second graph of response time r as a function of Cₗ and tᵣ;

FIG. 9 is a table of information entries of an illustrative embodiment according to the invention;

FIG. 10 is an illustration of a first multi-stage version of the technique of an illustrative embodiment according to the invention;

FIG. 11 is an illustration of a second multi-stage version of the technique of an illustrative embodiment according to the invention;

FIG. 12 is a first graph of average percentage error as a function of Cₗ and tᵣ;

FIG. 13 is a second graph of average percentage error as a function of Cₗ and tᵣ; and

FIG. 14 is a schematic electrical circuit diagram of circuitry, including a biased path, created according to an illustrative embodiment according to the invention.

### DETAILED DESCRIPTION

Illustrative and exemplary embodiments and their advantages are better understood by referring to FIGS. 1-14 of the drawings.

FIG. 1 is a block diagram of a system, indicated generally at 100, for processing information according to an illustrative embodiment according to the invention. System 100 includes input devices 104, a display device 106, a print device 108, and a computer 102 for executing processes and performing operations (e.g., communicating information) in response thereto as discussed further below. Computer 102 is connected to input devices 104, display device 106 and print device 108. Display device 106 is, for example, a conventional electronic cathode ray tube. Print device 108 is, for example, a conventional electronic printer or plotter.

Moreover, system 100 includes a computer-readable medium (or apparatus) 110, such as a floppy computer diskette or a computer hard drive. Computer-readable medium 110 and computer 102 are structurally and functionally interrelated with one another as described further below. Computer-readable medium 110 stores (or encodes, or records, or embodies) functional descriptive material (e.g., including but not limited to computer programs (also referred to as computer applications) and information structures). Such functional descriptive material imparts functionality when encoded on computer-readable medium 110. Also, such functional descriptive material is structurally and functionally interrelated to computer-readable medium 110.

Within such functional descriptive material, information structures define structural and functional interrelationships between such information structures and computer-readable medium 110 (and other aspects of system 100). Such interrelationships permit the information structures' functionality to be realized. Also, within such functional descriptive material, computer programs define structural and functional interrelationships between such computer programs and computer-readable medium 110 (and other aspects of system 100). Such interrelationships permit the computer programs' functionality to be realized.

For example, computer 102 reads (or accesses, or copies) such functional descriptive material into a computer memory of computer 102, and computer 102 performs its operations (as described elsewhere herein) in response to such material which is stored in such computer memory. More particularly, computer 102 performs the operation of processing a computer application (that is stored, encoded, recorded or embodied on a computer-readable medium) for causing computer 102 to perform additional operations (as described elsewhere herein). Accordingly, such functional descriptive material exhibits a functional interrelationship with the way in which computer 102 executes its processes and performs its operations.

Further, the computer-readable medium is an apparatus from which the computer application is accessible by computer 102, and the computer application is processable by computer 102 for causing computer 102 to perform such additional operations. In addition to reading such functional descriptive material from computer-readable medium 110, computer 102 is capable of reading such functional descriptive material from (or through) a network (not shown in FIG. 1) which is also a computer-readable medium (or apparatus). Moreover, the computer memory is itself a computer-readable medium (or apparatus).

A human user 112 and computer 102 operate in association with one another. For example, in response to signals from computer 102, display device 106 displays visual images, and user 112 views such visual images. Also, in response to signals from computer 102, print device 108 prints visual images on paper, and user 112 views such visual images. Further, user 112 operates input devices 104 in order to output information to computer 102, and computer 102 receives such information from input devices 104.

Input devices 104 include, for example, a conventional electronic keyboard and a pointing device such as a conventional electronic “mouse,” roller ball, or light pen. User 112 operates the keyboard to output alphanumeric text information to computer 102, and computer 102 receives such alphanumeric text information from the keyboard. User 112 operates the pointing device to output cursor-control information to computer 102, and computer 102 receives such cursor-control information from the pointing device.

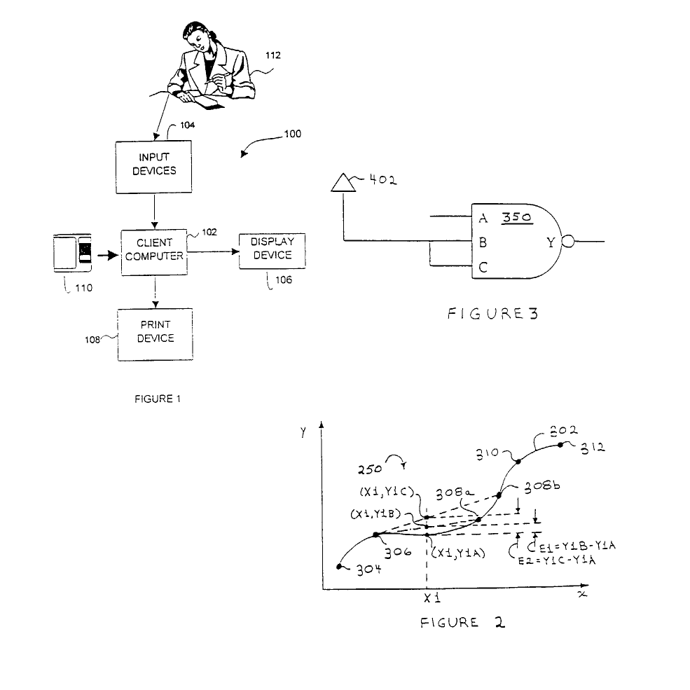

In the performance by system 100 of operations in accordance with the techniques (as discussed further below) of illustrative and exemplary embodiments, display device 106 displays the visual images of FIGS. 2 through 14 in response to signals from computer 102, and print device 108 prints such visual images on paper in response to signals from computer 102.

FIG. 2 is a graph, indicated generally at 250, of an example curve 302, for illustrating such a concept in exemplary embodiments. It is important for system 100 to accurately perform cell characterization by modeling (or “describing”) the cell's timing properties. Also, in designing integrated circuitry, a human designer specifies timing constraints that apply to the integrated circuitry. In response to such constraints and cell characterization information, automated computer software performs synthesis and timing verification operations to compile and validate a gate-level design (“netlist”) of the cell. Accordingly, accurate cell characterization is important for meeting performance goals in deep-submicron designs.

Note that, although the above description refers to cell timing characterization, one may apply the techniques according to the invention to modeling and characterization of other cell characteristics, as persons skilled in the art with the benefit of the description of the invention understand. One such characteristic constitutes cell power dissipation or consumption. Furthermore, timing response surfaces have relatively slight curvature, whereas power response surfaces exhibit relatively greater nonlinearities, making the application of the inventive techniques even more advantageous.

The operations of integrated circuitry cells may be characterized (or “represented” or “described” or “modeled”) by mathematical equations (“characteristic equations”) and other information (collectively referred to as “cell characterization information”). A characterization table includes multiple characteristic equations, which may be relatively simple fixed-form equations, in a manner analogous to the representation of complex functions by piecewise linear approximations of curves.

Alternatively, operations of such cells may be characterized by a single monolithic characteristic equation, both in terms of cell node-to-pin delay as well as the transition time of the signal at the output node. Nevertheless, such a single monolithic equation likely is relatively complex and often involves square and logarithmic terms for modeling inherent nonlinearities of the cell's propagation delay, output transition time and/or power dissipation. For example, the single monolithic characteristic equation may have nonlinear elements for accurately representing inherent nonlinearities in the operations of such cells. Such a characteristic equation may have product and log terms on the function variables and may include a few coefficients or many (e.g., 20 or more) coefficients.

Note that in some circumstances one may wish to use a characteristic equation, rather than a characterization table. For example, rather than storing information in a 1×1 characterization table, one may choose to use a single characteristic equation. Using a characteristic equation and compressing the data into a single equation avoids the use of a characterization table. Note further that, alternatively, one may use a characteristic equation, rather than a characterization table, as desired.

Unlike a single monolithic characteristic equation, the characterization table of illustrative embodiments is a multi-dimensional table (such as a 1×1 table the situation described above, or larger) for representing the cell's operation(s) in response to (or “as a function of”) various types and ranges of conditions (e.g., input transition time, output capacitive loading (“output load”), temperature, voltage and process). Instead of using only a single set of coefficients to describe the cell's operation(s), the characterization table includes multiple sets of coefficients/equations to describe the cell's operation(s) across various ranges of conditions (e.g., various ranges of input transition time, output load, temperature, voltage and process).

The number of dimensions of the table depends on how many desired operations or attributes of the cell system 100 represents. Thus, as persons of ordinary skill in the art who have the benefit of the description of the invention understand, one may use tables with appropriate dimensions to represents as many of cell's operations or attributes, as desired. The choice of the number of dimensions depends on a number of factors, such as the type of cell, the number of operations or attributes one seeks to represent, and the resources of system 100, such as processing power or time, memory, storage, etc., as persons skilled in the art with the benefit of the description of the invention understand.

Note that, generally, in exemplary embodiments according to the invention one may represent the cell's operation(s) in response to or as a function of various types and ranges of conditions, such as rise time, fall time, output transition time generally, input transition time generally, output capacitive loading or output load, operating temperature, one or more voltages pertaining to the cell, semiconductor fabrication process, and the like, as desired. Furthermore, one may represent the cell's operation(s) in response to or as a function of various types of output load, for example, a Π-configuration load (two capacitors and a resistor coupled in a Π configuration that represent or model the output load), as desired. Generally, one may use a single variable or virtually as many variables as desired (depending, of course, on the type and amount of resources, such as memory, storage, processing time, etc., available or desired).

In such a manner, characterization tables form piecewise linear (or non-linear, as desired) approximations of a complex curve. In a significant aspect of the exemplary embodiments, for accuracy within the characterization table, system 100 selects characterization points within regions of the complex curve that deviate the most from the equation approximation used in the characterization table. As noted above, however, depending on the circumstances (e.g., a 1×1 characterization table), one may use a single characteristic equation, as desired.

In exemplary embodiments, system 100 executes software programs for simulating a cell's operation as a function of the conditions of input transition time and output load. In alternative embodiments, system 100 executes a software program for simulating a cell's operation as a function of at least three types of conditions. For example, in one alternative embodiment, system 100 executes a software program for simulating a cell's operation as a function of output load and at least two types of input transition time conditions, namely a clock signal's input transition time and an operand signal's input transition time.

As an example in exemplary embodiments, for determining (or “measuring”) the cell's operation(s) in response to a specified combination of input transition time and output load, system 100 executes a software program for simulating the cell's operation(s) (“circuit simulator”) such as a software simulation program with integrated circuit emphasis (“SPICE”). Nevertheless, as a result of constraints on time and computer resources (e.g., computer memory and execution time), it is not practical for system 100 to measure the cell's operation(s) in response to all likely input transition times and output loads.

Instead, system 100 measures the cell's operation(s) in response to a pre-selected number of input transition times and output loads. A combination of a particular input transition time and a particular output load may be referred to as a characterization point. By prudently selecting the characterization points, system 100 creates an accurate characterization table while reducing the table's size.

In a significant aspect of exemplary embodiments according to the invention, system 100 performs dynamic programming and over-sampling operations for creating such a characterization table, as discussed further below. Advantageously, system 100 performs such operations by measuring and recording the cell's operation(s) in response to a subset of all likely input transition times and output loads. Such a goal presents significant challenges which are addressed by system 100.

For example, referring to FIG. 2, it is not practical for system 100 to measure y (e.g., an operation of a cell, such as the cell's output response (or “transition”) time or the cell's propagation delay) in response to every possible value of x (e.g., a characteristic of the cell, such as the cell's output load or the cell's input transition time). Instead, in the example of FIG. 2, system 100 measures y in response to x only at five points, namely points 304, 306, 308a, 310 and 312. If y is unmeasured in response to a particular value of x, system 100 determines y in response to selected pair of measured points 304, 306, 308a, 310 and 312 that most closely bound the particular value of x. More particularly, system 100 interpolates between the selected pair in order to determine the unmeasured y in response to the particular value of x. By performing such interpolation, system 100 estimates the cell's operation.

In FIG. 2, y is unmeasured in response to x=X1. In this example, if system 100 had executed SPICE to measure y in response to X1, system 100 would have measured y=Y1A. Nevertheless, because y is unmeasured in response to x=X1, system 100 determines y in response to selected pair of measured points 304, 306, 308a, 310 and 312 that most closely bound X1. Accordingly, in the example of FIG. 2, system 100 selects the pair of measured points 306 and 308a, because such points (among the measured points) most closely bound X1. After selecting the pair of measured points 306 and 308a, system 100 interpolates between the selected pair in order to determine the unmeasured y in response to X1. By performing such interpolation, system 100 estimates y=Y1B. An error E1=(Y1B−Y1A) results from such interpolation, as indicated in FIG. 2.

It is important to carefully select the points which are to be measured and stored in a characterization table, because system 100 relies upon such measured points in order to accurately estimate the cell's operation(s) in response to particular unmeasured points. A random sampling of points (which are to be measured and stored) is not preferred. This is because a random sampling may result in relatively low accuracy when system 100 interpolates between the measured points.

For example, in FIG. 2, if measured point 308a is replaced by a measured point 308b, then system 100 selects the pair of measured points 306 and 308b as the measured points most closely bounding X1. After selecting the pair of measured points 306 and 308b, system 100 interpolates between the selected pair in order to determine the unmeasured y in response to X1. By performing such interpolation, system 100 estimates y=Y1C. An error E2=(Y1C−Y1A) results from such interpolation, as indicated in FIG. 2. Advantageously, E1 is smaller than E2, as a result of system 100 measuring point 308a instead of point 308b. This example helps explain the importance of system 100 carefully selecting the points that system 100 measures and stores in a characterization table.

FIG. 3 is a schematic electrical circuit diagram of a 3-input NAND gate 350 for illustrating a concept of an illustrative embodiment according to the invention. NAND gate 350 has input nodes A, B, and C. Also, NAND gate 350 has an output node Y.

Propagation delay (t_{d}) and output transition time (tₒᵤₜ) are a function of input transition time (tᵢₙ) and capacitive load (Cₗ). Accordingly, system 100 characterizes a cell by executing SPICE in response to information, such as information representing a voltage stimulus at an input node, a capacitive load (Cₗ) at the output node, and constant voltages (e.g., voltages V_{DD} or V_{SS}) or transitioning (e.g., rising or falling) voltages at non-characterized nodes. Voltage V_{DD} represents a true binary logic 1 state of a supply voltage node 402. Voltage V_{SS} represents a false binary logic 0 state of a reference (“ground”) voltage node (not shown in FIG. 3).

Note that various cell characteristics, such as propagation delay, output transition time, power dissipation, etc., may be functions of more variables than input transition time and capacitive load, as persons skilled in the art with the benefit of the description of the invention understand. Furthermore, note that, rather than voltage stimuli, capacitive loads, and constant voltages, system 100 may use other types of stimulus or load, or both, as persons of ordinary skill in the art who have the benefit of the description of the invention understand. For example, system 100 may apply current stimuli, resistive-capacitive loads (such as Π-configuration loads) or other types of load, and constant currents, as desired. Generally, the type of stimulus and load depends on the particular circuitry within the cell, the specific type of circuit simulator, and the like.

As an operational example, in characterizing a delay between “characterized” nodes A and Y, system 100 executes SPICE in response to information representing a constant voltage V_{DD} at non-characterized nodes B and C. In such a situation where A and Y are the characterized nodes, system 100 characterizes the operation of NAND gate 350 as an inverter having input node A and output node Y.

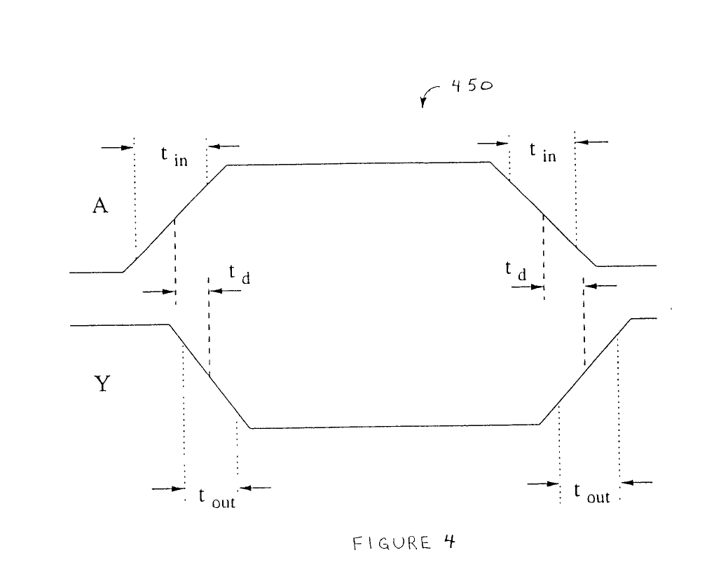

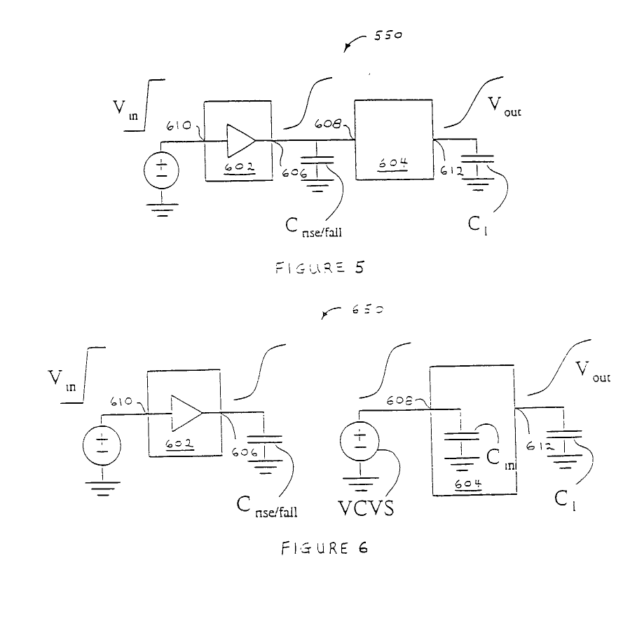

FIG. 4 is a graph, indicated generally at 450, of voltages at nodes A and Y, as a function of time. For characterizing the delay between nodes A and Y, system 100 executes SPICE for determining output transition time (tₒᵤₜ) at node Y and propagation delay (t_{d}) between nodes A and Y, as shown in FIG. 4, in response to (a) an input voltage at node A having a pre-selected input transition time (tᵢₙ) and (b) a pre-selected capacitive load at node Y. System 100 performs such characterization in response to a variety of different values of input transition time at node A, plus a variety of different values of capacitive load at node Y.

In exemplary embodiments, system 100 measures t_{d} at the 50% point of V_{DD}. Also, system 100 measures tᵢₙ and tₒᵤₜ along the substantially linear region of the voltage transition, normally between the 10% and 90% points (or, alternatively, between the 20% and 80% points) of V_{DD}.

System 100 determines and stores such characterization information for various types of cells. For each type of cell, system 100 performs such characterization in response to information representing a voltage stimulus at an input node, a capacitive load at the output node, and constant voltages at non-characterized nodes, such that system 100 determines variable voltages at characterized nodes. System 100 performs such characterization for various combinations of input nodes and output nodes. More particularly, while system 100 characterizes a particular input node in combination with a particular output node, other input nodes and other output nodes are non-characterized (e.g., system 100 represents such other input nodes as having constant voltages).

Note that, generally, system 100 may determine and store characterization information for a variety of cells, stimuli, and/or loads. For each type of cell, system 100 may perform characterization in response to information representing a general stimulus, such as voltage or current, at one or more input nodes, a capacitive load or other type of output load, and constant stimuli (e.g., voltages or currents) at non-characterized nodes. Under such circumstances, system 100 determines variable quantities (e.g., voltages or currents) at characterized nodes. System 100 may conduct characterization for various combinations of input nodes and output nodes, as desired.

Further, system 100 performs (and stores) such characterization multiple times in response to a variety of different values of input transition time (or other attribute) at the characterized input node (or nodes), plus a variety of different values of capacitive load (or other type of load) at the characterized output node (which is being characterized in combination with the characterized input node or nodes). This is advantageous relative to previous techniques that characterize only a small number (e.g., 4) of values for such capacitive load Cₗ, each in combination with only a single respective input transition time. Moreover, according to some previous techniques, for each value of Cₗ, the single respective input transition time is the average of a few (e.g., 4) input transition times, each of which is measured in response to a different value of capacitive load C_{rise/fall} at the characterized input node.

For each characterized input node, system 100 performs the characterization (a) first, in response to information representing a rising voltage stimulus at the characterized input node, and (b) second, in response to information representing a falling voltage stimulus at the characterized input node. In that manner, for each characterized input node, system 100 characterizes tᵢₙ in two forms, namely (a) tᵢₙ=t_{LH}_{ᵢ} for a low-to-high transition and (b) tᵢₙ=t_{HL}_{ᵢ} for a high-to-low transition. Likewise, in that manner, for each characterized output node, system 100 characterizes tₒᵤₜ in two forms, namely (a) tₒᵤₜ=t_{LH}_{ₒ} for a low-to-high transition and (b) tₒᵤₜ=t_{HL}_{ₒ} for a high-to-low transition.

Generally, cells are either unate or binate. For a binate cell, such as an exclusive-OR (“XOR”) gate, polarity (i.e., either t_{LH}_{ₒ} or t_{HL}_{ₒ}) of tₒᵤₜ is a function not only of polarity (i.e., either t_{LH}_{₁} or t_{HL}_{₁}) of tᵢₙ, but also of respective conditions at one or more non-characterized nodes, such as (a) whether one or more non-characterized nodes is respectively biased to a true binary logic 1 state or instead to a false binary logic 0 state and/or (b) whether one or more non-characterized nodes receives a respective signal having a positive (e.g., rising voltage) transition or instead a negative (e.g., falling voltage) transition. Accordingly, for each characterized binate cell, system 100 performs such characterization in response to information representing various sets of conditions at non-characterized nodes, so that all states of the cell are characterized.

For example, in characterizing an XOR gate having input nodes A and B and an output node Y, system 100 performs such characterization for characterized nodes A and Y (a) first, in response to a constant voltage V_{DD} at node B, and (b) second, in response to a constant voltage V_{SS} at node B. When node B has a constant voltage V_{SS}, the XOR gate operates as a buffer. In contrast, when node B has a constant voltage V_{DD}, the XOR gate operates as an inverter.

In the process of designing and creating integrated electronic circuitry, human designers and computers may create a library of logic functionality, rather than designing each logic gate individually. From the library,.human designers and computers may select components for implementing logical functionality within the physical integrated electronic circuitry. Such a library is sometimes referred to as a standard cell library, and it forms a basic building block for design and creation of the circuitry. System 100 characterizes the propagation delay and output transition time of standard cells in such a library. Although the description of the invention discusses propagation delay and output transition time, generally, system 100 may characterize a variety of cell attributes, as desired.

Cell libraries also include cell timing characteristics for performing static and dynamic timing analysis. Within such a library, the number of cells varies, as does the type of cell functionality. Such a library may include, for example, as many as 40 to 50 different types of Boolean functions. Each Boolean function may have multiple sizes or “drive strengths.”

For example, a library may include 6 to 8 different types of inverters. Relative to a large inverter, a small inverter has a smaller input node capacitance, intrinsic delay, and area. Relative to a small inverter, a large inverter can drive a greater number of capacitive loads or a longer interconnect route. Preferably, circuitry is designed and created to minimize area and/or timing while satisfying the imposed design constraints. Thus, a library preferably includes various components to enable selection among a wide range of drive strengths and functionality.

Cells may be named according to their functionality and drive strength. For example, a library may contain inverters named INV_A, INV_B, INV_C, INV_D, INV_E, and INV_F. Drive strengths are meaningful indicators and may be shared across different functions. For example, all cells with a drive strength of D may be capable of driving a substantially equal amount of capacitive load.

In exemplary embodiments according to the invention, system 100 characterizes a cell within a library by executing SPICE for determining propagation delays and output transition times of the characterized cell. In response to these determined times and delays, system 100 further determines values of coefficients in a characteristic equation (or in multiple characteristic equations within a characterization table), according to a generalized curve-fitting technique such as least-squares. Characterization models of exemplary embodiments according to the invention include a driving cell (e.g., an inverter or buffer), in addition to the characterized cell.

Although a driving cell may be modeled (or “represented”) as a form of ideal voltage supply with a current-limiting resistor, input transition times are not fully linear. This is because characterized cells would not usually receive fully linear voltages at their input nodes. Thus, such an ideal voltage supply is not a preferred model.

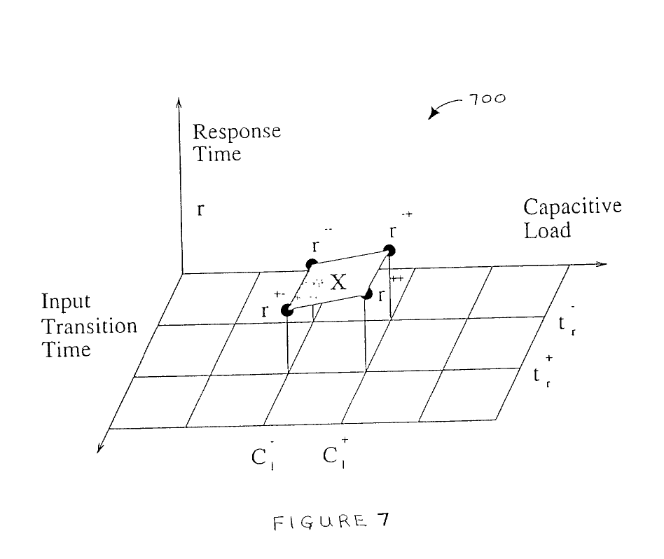

FIG. 5 is a schematic electrical circuit diagram, indicated generally at 550, of a driving cell 602 and a characterized cell 604. In FIG. 5, an output node 606 of driving cell 602 is coupled to an input node 608 of characterized cell 604. In response to a voltage Vfᵢₙ at an input node 610 of driving cell 602, along with a varying capacitive load C_{rise/fall} at output node 606, voltages having transition times of varying length are generated at output node 606.

In response to Vᵢₙ transitioning from a first voltage (representing a first logic state) to a second voltage (representing a second logic state) in a substantially linear manner, driving cell 602 outputs (or “generates”) a voltage signal at output node 606. A particular transition time of such a voltage signal (at output node 606) is achieved by selecting a suitable value of C_{rise/fall}. Because output node 606 is coupled to input node 608, voltages generated at output node 606 are likewise generated at input node 608. Moreover, in exemplary embodiments according to the invention, system 100 characterizes a cell in response to a variety of different values of C_{rise/fall} and Cₗ (i.e., capacitive load at an output node 612 of characterized cell 604.

FIG. 6 is a schematic electrical circuit diagram, indicated generally at 650, of a modified version of circuitry 550. As indicated in FIG. 6, input node 608 has an intrinsic capacitance Cᵢₙ. Accordingly, a shortcoming of the model of FIG. 5 is that a value of Cᵢₙ varies according to the transition time of the voltage generated at output node 606. Thus, with the model of FIG. 5, it is difficult to select a suitable value of C_{rise/fall} for achieving a particular transition time.

By comparison, in the model of FIG. 6, driving cell 602 is electrically isolated from characterized cell 604. Circuitry 650 includes a voltage-controlled-voltage-source (“VCVS”) for generating a voltage signal at input node 608 which is substantially equal to the voltage signal generated at output node 606. With the model of FIG. 6, a suitable value of C_{rise/fall} is more readily determined to achieve a particular transition time of the voltage signals at nodes 606 and 608.

FIG. 7 is graph, indicated generally at 700, of response time r as a function of Cₗ and tᵣ, where r=tₒᵤₜ or t_{d}, and where tᵣ=tᵢₙ (i.e., either t_{LHi} or t_{HL1}). FIG. 7 shows four characterization points, namely (tᵣ⁺, Cₗ⁺), (tᵣ⁺, Cₗ⁻), (tᵣ⁻, Cₗ^{+), (t}ᵣ^{-, C}ₗ⁻) most closely adjacent (or “proximate”) to a point X. In this example, system 100 has executed SPICE for a particular “to-be-characterized” cell to determine respective values of r in response to the respective values of tᵣ and Cₗ which define characterization points (tᵣ⁺, Cₗ⁺), (tᵣ⁺, Cₗ⁻), (tᵣ⁻, Cₗ⁺), (tᵣ⁻, Cₗ⁻), but system 100 has not executed SPICE to determine a value of r in response to the particular values of tᵣ and Cₗ which define point X. System 100 stores such determined values of r (associated with characterization points (tᵣ⁺, Cₗ⁺), (tᵣ⁺, Cₗ⁻), (tᵣ⁻, Cₗ⁺), (tᵣ³¹ , Cₗ⁻)) in a characterization table. Generally, note that system 100 may execute SPICE for other points in FIG. 7 and store the results (for example, in a characterization table), as desired.

Nevertheless, it may be helpful for system 100 to accurately determine an estimated value of r at point X. For example, system 100 may execute a static timing analysis software package in response to such estimate, in order to analyze timing interrelationships between multiple characterized cells that are coupled to one another within integrated electronic circuitry. In performing such analysis, the static timing analysis software package may incorporate various predetermined assumptions regarding the operations of such integrated electronic circuitry. Before executing the static timing analysis software package in response to the estimated value of r (at point X), accuracy is enhanced by determining such estimated value of r (at point X) in a manner consistent with such predetermined assumptions.

For example, one such predetermined assumption is the relationship between r, tᵣ and Cₗ. Such relationship may be expressed in the form of a characteristic equation. Thus, accuracy is enhanced by estimating the value of r at point X in a manner consistent with such characteristic equation.

One static timing analysis software package is commercially available from Synopsys, having an address at 700 East Middlefield Rd., Mountain View, Calif. 94043, a telephone number (650) 962-5000, and a global computer network address of http://www.synopsys.com. Such a package uses the following characteristic equation to express the relationship between r, tᵣ and Cₗ:

r=f(tᵣ, Cₗ)=A*tᵣ+B*Cₗ+C*tᵣ*Cₗ+D. (1)

Note, however, that one may use a variety of other static timing analysis software packages and/or characteristic equations. Exemplary characteristic equations may constitute the well-known Taylor's series expansion or the Maclaurin series expansion. For a function r(x) such that

$$r ( x ) = {\sum }_{n = 0}^{∞} {{a}_{n} ( x - c )}^{n} ,$$

for all x in an open interval containing c, then

$$r ( x ) = r ( c ) + {r}^{′} ( c ) ( x - c ) + \frac{{r}^{″} ( c )}{2 !} {( x - c )}^{2} + … + \frac{{r}^{( n )} ( c )}{n !} {( x - c )}^{n} + …$$

If the function r has derivatives of all orders through the interval containing c, and if

$${lim}_{n \to ∞} {R}_{n} ( x ) = 0 , \\ where$$

$${R}_{nf} ( x ) = \frac{{r}^{( n + 1 )} ( z )}{( n + 1 ) !} {( x - c )}^{n + 1}$$

where

for some number z between c and x, then for every x in the interval the Taylor's series represents r(x) at c.

Note that letting c=0 results in the well-known Maclaurin series for the function r(x). Limiting to n (a number prescribed or chosen by the user 112) the degree of the polynomial in the Taylor's series above, one may generally re-write the Taylor's series as:

r(x)=a₀+a₁(x−c)+a₂(x−c)²+. . . +aₙ(x−c)ⁿ, (2a)

where a₀-aₙ constitute coefficients for the various termns. Where c=0, one obtains:

r(x)=a₀+a₁x+a₂x²+. . . +aₙxⁿ. (2b)

As persons of ordinary skill in the art know, one may obtain Taylor's series or Maclaurin series representations for a function r of several variables x₁, X₂, . . . , xᵢ, rather than a single variable (i.e., a multi-variable Taylor's series or Maclaurin series representation). For example, for two variables x₁ and x₂, one may write:

$$r ( x ) = {a}_{0} + {a}_{1} {x}_{1} + {a}_{2} {x}_{2} + {a}_{3} {x}_{1}^{2} + {a}_{4} {x}_{1} {x}_{2} + {a}_{5} {x}_{2}^{2} + {a}_{6} {x}_{1}^{3} + {a}_{7} {x}_{1}^{2} {x}_{2} + {a}_{8} {x}_{1} {x}_{2}^{2} + {a}_{9} {x}_{2}^{3} + … + {a}_{m} {x}_{1}^{n} + … + {a}_{k} {x}_{2}^{n} .$$

Note that one may expand or modify the above equation to accommodate other numbers of variables, as desired. The expansion or modification falls within the knowledge of persons of ordinary skill who have the benefit of the description of the invention.

The variables x₁, x₂, . . . , xᵢ, may represent various circuit or environmental attributes, such as rise time, fall time, output transition time generally, input transition time generally, output capacitive loading or output load, operating temperature, one or more voltages pertaining to the cell, semiconductor fabrication process, and the like, as desired. For example, one may let x₁ represent tᵣ and x₂ represent Cₗ, as desired. Note that one may further use other attributes of the circuit as the variables, as desired. Furthermore, one may use other numbers of variables, as desired.

Rather than, or in addition to the characteristic equation (1), the system 100 may also determine and store the coefficients for a desired characteristic equation (2) (i.e., a Taylor's series or Maclaurin series expansion). Moreover, the user 112 may prescribe the number of terms and/or the degree of the Taylor's series or Maclaurin series expansion, as desired. Thus, the system 100 can determine a Taylor's series or Maclaurin series expansion of an arbitrary or specified degree or with a prescribed number of terms, as specified by the user 112. The system 100 may also examine a number of different Taylor's series or Maclaurin series to determine which of the series to use to represent the given data (e.g., with the smallest error or with an error below a specified threshold, which the user 112 may specify to system 100). Alternatively, the system 100 may examine a number of Taylor's series or Maclaurin series and present the results as options. The user 112 may then select from among the Taylor's series or Maclaurin series that the system 100 presents, as desired.

With respect to the characteristic equation given by equation (1), system 100 is able to determine r at point X in a manner consistent with such characteristic equation, and without executing SPICE for point X. More particularly, system 100 identifies the aforementioned four characterization points that are most closely adjacent to point X, such that:

$${\overline{C}}_{l} \leq {C}_{l} \leq {{C}^{+}}_{l}$$

$${\overline{t}}_{r} \leq {t}_{r} \leq {{t}^{+}}_{r}$$

These four characterization points identify four entries in the characterization table, namely:

$$\begin{matrix}{r}^{--} = table ( {\overline{t}}_{r} , {\overline{C}}_{l} ) \\ {r}^{+ -} = table ( {{t}^{+}}_{r} , {\overline{C}}_{l} ) \\ {r}^{- +} = table ( {\overline{t}}_{r} , {{C}^{+}}_{l} ) \\ {r}^{++} = table ( {{t}^{+}}_{r} , {{C}^{+}}_{l} )\end{matrix}$$

For the characteristic equation given by equation (1), the system 100 determines real numbers A, B, C and D (i.e., constant elements) of the characteristic equation in response to the identified four characterization points (i.e., system 100 uses the four characterization points to solve for the four unknowns of such characteristic equation), such that:

$$[ \begin{matrix}{\overline{t}}_{r} & {\overline{C}}_{l} & {\overline{t}}_{r} * {\overline{C}}_{l} & 1 \\ {{t}^{+}}_{r} & {\overline{C}}_{l} & {{t}^{+}}_{r} * {\overline{C}}_{l} & 1 \\ {\overline{t}}_{r} & {{C}^{+}}_{l} & {\overline{t}}_{r} * {{C}^{+}}_{l} & 1 \\ {{t}^{+}}_{r} & {{C}^{+}}_{l} & {{t}^{+}}_{r} * {{C}^{+}}_{l} & 1\end{matrix} ] [ \begin{matrix}A \\ B \\ C \\ D\end{matrix} ] = [ \begin{matrix}{r}^{--} \\ {r}^{+ -} \\ {r}^{- +} \\ {r}^{++}\end{matrix} ] .$$

After determining the values of A, B, C and D, system 100 determines a value of r (in response to the particular values of tᵣ and Cₗ which define point X) in accordance with such characteristic equation and such determined values of A, B, C and D.

For the characteristic equation given by equation the Taylor's series or Maclaurin series expansion, the system 100 may generally determine the coefficients of the Taylor's series expansion (e.g., coefficients a₀, a₁, a₂, and so on) using all available data points, rather than the four characterization points discussed above in connection with the characteristic equation given by equation (1). In other words, because system 100 seeks to curve-fit (i.e., one or more curves specified by a Taylor's series expansion or a Maclaurin series expansion) to the entire response surface, it may use all data points as characterization points.

Note that system 100 may also use the four characterization points (i.e., the four corners of a region) discussed above in connection with a Taylor's series or Maclaurin series expansion, as desired. If one wishes to obtain a continuous representation expansion for the data, then one may use the four characterization points discussed above, as desired. The number of data points, however, places a limit or bound on the number of terms or coefficients in the Taylor's series or Maclaurin series expansion. In other words, the number of terms or coefficients in the Taylor's series or Maclaurin series expansion (i.e., the number of unknowns) does not exceed the number of data points used to obtain the terms or coefficients. Put another way, given L data points, one may fit L-3 curves to the L data points. Thus, generally, system 100 may use four or more data points, as desired.

Generally, system 100 may obtain a number of Taylor's series or Maclaurin series expansions, each for a subset of the data, as desired. In other words, system 100 may divide or group the data into subsets or sub-regions and obtain Taylor's series or Maclaurin series expansions for the subsets or sub-regions.

As one option, system 100 may use a subset of the data to obtain Taylor's series or Maclaurin series expansions and use another subset or all of the data to conduct error analysis. In other words, system 100 may use part of the data to obtain Taylor's series or Maclaurin series expansions and hold the rest of the data in reserve. Then, when it conducts its error analysis (as described below in detail), system 100 may use another subset of the data or all of the data, as desired. Doing so allows system 100 and/or user 112 to determine how well the Taylor's series or Maclaurin series expansions fit the data (i.e., how good the curve-fitting is). System 100 and/or user 112 may base that determination on the error analysis alone or on an analysis of the error together with other parameters or quantities, as described below in detail.

Once system 100 has determined a Taylor's series or Maclaurin series expansion for the data, it can store the coefficients or terms for the Taylor's series or Maclaurin series and the error corresponding to the particular series. A Taylor's series or Maclaurin series that has L coefficients (i.e., the same number of coefficients or terms as the number of data points) produces zero curve-fitting error. Taylor's series or Maclaurin series that have fewer than L coefficients, however, produce finite errors. System 100 can store the errors corresponding to various Taylor's and Maclaurin series, as desired. System 100 may then combine or use a combination of two or more of the Taylor's series or Maclaurin series expansions in order to curve-fit the entire data set.

User 112 may provide criteria that prescribe the number of data points system 100 uses, and/or how many and/or how many and/or how many coefficients or terms it stores. For example, the user 112 may prescribe a limit for the total number of coefficients or terms for the Taylor's series or Maclaurin series expansion that system 100 stores. System 100 tracks the total number of coefficients or terms and compares that total to the number that user 112 prescribes. As another alternative, user 112 may specify the number of data points system 100 uses to obtain Taylor's series or Maclaurin series expansions. User 112 may take into account trade-offs among storage requirements, available memory, processing speed, and the like, to select the number of coefficients or terms or the number of data points used in Taylor's series or Maclaurin series expansions.

As yet another alternative, the system 100 may select the number of coefficients or terms, the number of Taylor's or Maclaurin series expansions used, and/or the number of data points, as desired, by using heuristics, look-up tables, or similar techniques. The system 100 may select the number of coefficients or terms, the number of expansions, and/or the number of data points by using criteria that user 112 provides (e.g., maximum amount of memory available, maximum amount of storage to use, etc.), as persons skilled in the art with the benefit of the description of the invention understand.

After determining the Taylor's series or Maclaurin series coefficients or terms, system 100 determines a value of r (in response to the particular values of tᵣ and Cₗ that define point X) in accordance with such characteristic equation (i.e., a Taylor's series expansion or Maclaurin series) and such determined values of the coefficients for the Taylor's series or Maclaurin series expansion.

As explained further hereinabove in connection with FIG. 2, it is important to carefully select the points to be characterized by system 100. This is because some characterization points (in comparison to other possible characterization points) will enable system 100 to more accurately determine an estimated value of r (in response to the particular values of tᵣ and Cₗ which define point X). By more accurately determining this estimated value of r, system 100 more accurately executes the static timing analysis software package in response to such estimate, so that system 100 more accurately analyzes timing interrelationships between multiple characterized cells that are coupled to one another within integrated electronic circuitry.

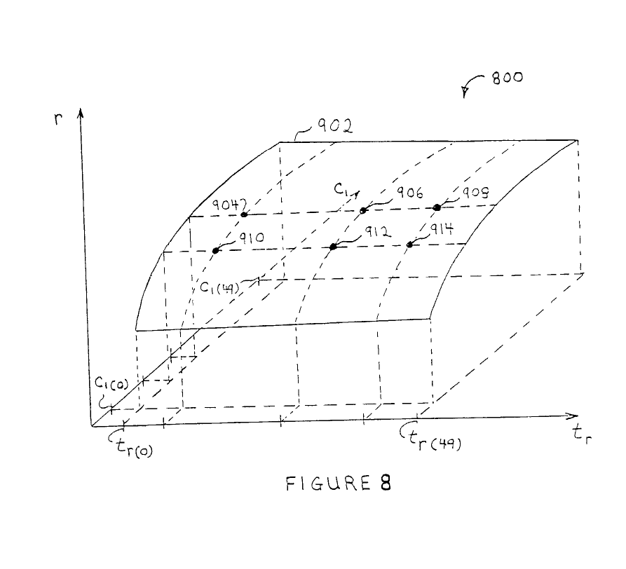

FIG. 8 is a graph, indicated generally at 800, of response time r as a function of Cₗ and tᵣ. In the following example, system 100 selects characterization points from among 2500 candidate points along surface 902. Nevertheless, the manner in which the number of candidate points is adjustable will be readily apparent. By selecting characterization points from among a number of candidate points, system 100 performs oversampling and pruning operations as discussed further below.

Accordingly, in the example of FIG. 8, four points (tᵣ₍₀₎, Cₗ₍₀₎), (ₜᵣ₍₀₎, Cₗ₍₄₉₎), (tᵣ₍₄₉₎, Cₗ₍₀₎) and (tᵣ₍₄₉₎, Cₗ₍₄₉₎) define the corner points of a surface 902. Surface 902 represents r=f(Cₗ, tᵣ), where f(Cₗ, tᵣ) is a characteristic equation such as equation (1) or a Taylor's series or Maclaurin series expansion discussed further hereinabove (or, alternatively, where f(Cₗ, tᵣ) is a characterization table). In a significant aspect of exemplary embodiments according to the invention, system 100 determines a respective combination of tᵣ₍₀₎, Cₗ₍₀₎, tᵣ₍₄₉₎ and Cₗ₍₄₉₎ separately (e.g., independently, individually) for each characterization table of each characterized cell.

For example, for a unate cell, system 100 creates a respective set of characterization tables for a particular combination of an input node and an output node. Each set of characterization tables includes (a) a first table for output transition time (tₒᵤₜ) at the characterized output node in response to a variety of different values of Cₗ and tᵢₙ=t_{LH1}, (b) a second table for output transition time (tₒᵤₜ) at the characterized output node in response to a variety of different values of Cₗ and tᵢₙ=t_{HL1}, (c) a third table for propagation delay (t_{d}) between the characterized input and output nodes in response to a variety of different values of Cₗ and tᵢₙ=t_{LHi}, and (d) a fourth table for propagation delay (t_{d}) between the characterized input and output nodes in response to a variety of different values of Cₗ and tᵢₙ=t_{HL1}. For a binate cell, system 100 creates additional characterization tables in accordance with the discussion further hereinabove in connection with FIG. 4.

In exemplary embodiments according to the invention, the value of Cₗ₍₀₎ is either (a) specified by human user 112 of system 100 or (b) initialized (or “established”) at zero by system 100. Also, system 100 determines the value of tᵣ₍₄₉₎ in response to a maximum acceptable output transition time for the characterized output node (as specified by human user 112). Further, system 100 executes SPICE for determining the value of Cₗ₍₄₉₎ as a function of tᵣ₍₄₉₎. Moreover, system 100 establishes the value of tᵣ₍₀₎ as being equal to the shortest transition time (of a voltage output by a driving cell, such as the voltage output at node 606 by cell 602 of FIG. 6) achieved by driving cells of the particular cell library being characterized.

As mentioned hereinabove, in this example, system 100 selects characterization points from among 2500 (i.e., N², where N=50) candidate points along surface 902. Accordingly, system 100 identifies such candidate points as (t_{r(A)}, C_{l(B)}), where A is an integer number ranging between 0 and N−1, and B is an integer number ranging between 0 and N−1. (Notably, integers A and B are distinct from real numbers A and B of equation (1) discussed further hereinabove in connection with FIG. 7.) In exemplary embodiments according to the invention, the values of t_{r(A)} are tᵣ₍₀₎*10^{(A*F)}, and the values of C_{l(B)} are Cₗ₍₀₎*10^{(A*G)}, where:

F=|log(tᵣ₍₄₉₎)−log(tᵣ₍₀₎)|÷(N−1)

G=|log(Cₗ₍₄₉₎)−log(Cₗ₍₀₎)|÷(N−1)

Advantageously, such logarithmic terms help ensure that more candidate points are located at lower values of tᵣ and Cₗ, where surface 902 is more likely to be curved.

In an alternative embodiment for distributing candidate points more evenly along surface 902, the values of t_{r(A)} are tᵣ₍₀₎+(A*J), and the values of C_{l(B)} are Cₗ₍₀₎+(A* K), where:

J=|tᵣ₍₄₉₎−tᵣ₍₀₎|÷(N−1)

K=|Cₗ₍₄₉₎−Cₗ₍₀₎|÷(N−1).

In the illustrative embodiment, the number of selected characterization points is a number C=V*W, where V is an integer number of t_{r(A)} coordinates and W is an integer number of C_{l(B)} coordinates. For example, as shown in FIG. 8, system 100 may select six characterization points 904, 906, 908, 910, 912 and 914 (from among the candidate points) by selecting V=3t_{r(A)} coordinates and W=2C_{l(B)} coordinates. Similarly, as another example, system 100 may select nine characterization points (from among the candidate points) by selecting V=3t_{r(A)} coordinates and W=3C_{l(B)} coordinates.

FIG. 9 is a table, indicated generally at 950, of N² information entries R_{A,B} associated with the N² candidate points (t_{r(A)}, C_{l(B)}), respectively. Finite memory and runtime limits of system 100 impose practical constraints on the size of tables such as table 950. Relative to larger tables, smaller tables consume fewer resources of system 100, but smaller tables may result in larger errors.

Preferably, in accordance with the discussion hereinabove in connection with FIG. 7, system 100 selects characterization points (i.e., a subset of candidate points (t_{r(A)}, C_{l(B)})) in the manner discussed further below, so that system 100 more accurately determines an estimated value of r (in response to particular values of tᵣ and Cₗ which define a point X). By more accurately determining this estimated value of r, system 100 more accurately executes a static timing analysis software package in response to such estimate, so that system 100 more accurately analyzes timing interrelationships between multiple characterized cells that are coupled to one another within integrated electronic circuitry.

For each identified candidate point (t_{r(A)}, C_{l(B)}), system 100 executes SPICE for determining a respective value of r (r_{SPICE}) in response to the particular values of tᵣ and Cₗ which collectively define such candidate point. Accordingly, system 100 generates (with, and according to, the computer-implemented SPICE model of the characterized cell's operation(s)) a first set of estimates of the characterized cell's operation(s) in response to a set of conditions, respectively. The first set of estimates is formed by the respective values of r (r_{SPICE}), and the set of conditions is formed by respective combinations of values of tᵣ and Cₗ which collectively define the candidate points. For example, (a) a first condition (of the set of conditions) is a particular value of tᵣ in combination with a particular value of Cₗ, which collectively define a particular candidate point, and (b) the first condition's respectively associated first estimate (which is one estimate of the first set of estimates) is a particular value of r (r_{SPICE}) that system 100 determines by executing SPICE in response to the first condition.

Then, system 100 determines (for each candidate point) the errors resulting from selection of such candidate point, and system 100 compares such errors to one another. Potentially, any candidate point may form the lower left corner (i.e., lowest values of A and B) of a region that includes a subset of other candidate points. Accordingly, in a significant aspect of exemplary embodiments according to the invention, for each candidate point (t_{r(A=X)}, C_{l(B=Y)}), system 100 determines the errors resulting from selection of such candidate point.

More particularly, in exemplary embodiments that use a characteristic equation given by equation (1) and a representation of the data as shown in FIG. 9, system 100 determines such errors (resulting from selection of candidate point (t_{r(A=X)}, C_{l(B=Y)})) by performing the following steps. First, system 100 determines real numbers A, B, C and D of the characteristic equation given by equation (1) above in response to candidate points (t_{r(A=X)}, C_{l(B=Y)}), (t_{r(A=X)}, C_{l(B=P=(N-1))}), (t_{r(A=M=(N-1)}), C_{l(B=Y)}) and (t_{r(A=M=(N-1)}), C_{l(B=P=(N-1))}), as discussed further hereinabove in connection with FIG. 7. (Notably, as mentioned hereinabove, real numbers A and B of equation (1) are distinct from integers A and B of the candidate points.)

After determining real numbers A, B, C and D (the coefficients of the characteristic equation given by equation (1)), system 100:

(a) for each candidate point (t_{r(X<A<M)}, C_{l(Y<B<P)}), determines a respective value of r (rᵢₙₜₑᵣₚₒₗₐₜₑ) in response to the particular values of tᵣ and Cₗ which collectively define such candidate point, in accordance with the characteristic equation given by equation (1);

(b) for each candidate point (t_{r(X<A<M)}, C_{1(y<B<P)}), determines a respective absolute (or signed, as desired) difference between such candidate point's respective value of rᵢₙₜₑᵣₚₒₗₐₜₑ and such candidate point's respective value of r_{SPICE};

(c) determines a sum of all such absolute differences for all candidate points (t_{r(X<A<M)}, C_{l(Y<B<P)}); and

(d) stores such sum at entry R_{A=X,B=Y} (of table 950) associated with candidate point (t_{r(A=X)}, C_{l(B=Y)}), such sum being the error resulting from selection of such candidate point “in combination with point (t_{r(A=M)}, C_{l(B=P)})”.

The above-described steps have been described specifically for a situation where (a) candidate point (t_{r(A=X)}, C_{l(B=Y)}) forms the lower left corner (i.e., lowest values of A and B) of a region that includes a subset of other candidate points and (b) point (t_{r(A=M=(N-1))}, C_{l(B=P=(N-1))}) forms the upper right corner (i.e., highest values of A and B) of such region.

Accordingly, for each condition (e.g., the first condition), system 100 generates (with, and according to, the computer-implemented characteristic equation model of the characterized cell's operation(s)) a respectively associated second set of estimates of the characterized cell's operation(s) in response to such condition, and further in response to various subsets of the first set of estimates (i.e., system 100 determines real numbers A, B, C and D of equation (1) in response to a subset of the first set of estimates).

For example, in an exemplary embodiment according to the invention, each subset includes (and is respectively associated with) four values of r_{SPICE} that are respectively associated with four candidate points which form four corners of a particular region. Each condition's respectively associated second set of estimates is formed by the values of r (rᵢₙₜₑᵣₚₒₗₐₜₑ) that system 100 determines in response to such condition. Such values are respectively associated with different regions that have different corners formed by different candidate points. Thus, such values and such regions are respectively associated with different sets of values for real numbers A, B, C and D of the characteristic equation given by equation (1) and the corresponding data shown in FIG. 9.

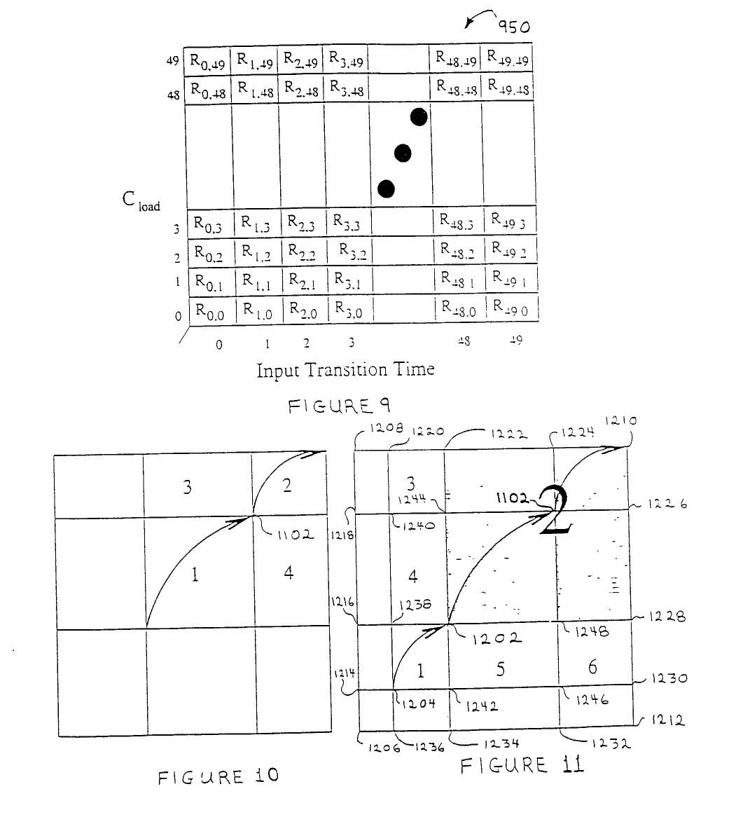

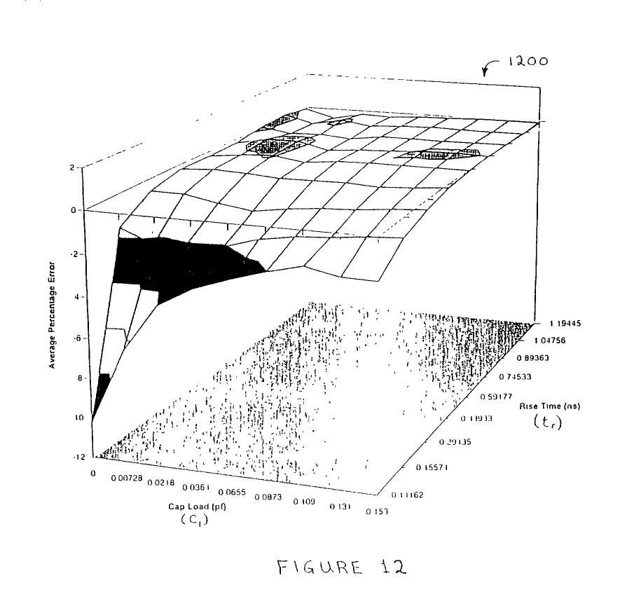

As discussed further below in connection with FIGS. 10 and 11, in response to a comparison between a condition's (e.g., the first condition's) (a) respectively associated first estimate and (b) respectively associated second set of estimates, system 100 selects a subset of the first set of estimates. Also, system 100 executes a static timing analysis software package in which system 100 determines real numbers A, B, C and D of the characteristic equation given by equation (1) in response to the selected subset. Moreover, in executing the static timing analysis software package, system 100 generates (with, and according to, the computer-implemented characteristic equation model of the characterized cell's operation(s)) estimates of the characterized cell's operation(s) in response to (a) respectively associated conditions (e.g., each condition being a particular value of tᵣ in combination with a particular value of Cₗ) and (b) such determined real numbers A, B, C and D of the characteristic equation given by equation (1). Advantageously, in executing the static timing analysis software package, system 100 generates such estimates without regard to (and independent of, and irrespective of) whether the conditions define previously identified candidate points.

FIG. 10 is an illustration of a first multi-stage version of the technique discussed hereinabove in connection with FIG. 9. In the multi-stage versions, system 100 determines (according to a multi-stage approach) the errors resulting from selection of candidate point (t_{r(A=X)}, C_{l(B=Y)}), for a situation where (a) candidate point (t_{r(A=X)}, C_{l(B=Y)}) forms the lower left corner of a region that includes a subset of other candidate points and (b) point (t_{r(A=M=(N-1))}, C_{l(B-P-(N 1))}) forms the upper right corner of such region. Under the multi-stage approach, system 100 determines a multi-stage error by adding the errors of all “subregions” included within such region.

For example, as indicated in FIG. 10, for an entry 1102 being R_{S,W} associated with point (t_{r(S)}, C_{l(W)}), where X<S<(N−1), and where Y<W<(N−1), system 100 determines a 2-stage error by adding:

(a) the error (“subregion 1 error”) stored at entry R_{X,Y} for the situation where point (t_{r(S)}, C_{l(W)}) forms the upper right corner of subregion 1 of FIG. 10 (i.e., the error resulting from selection of candidate point (t_{r(X)}, C_{l(Y)}) in combination with point (t_{r(S)}, C_{l(W)}));

(b) the error (“subregion 2 error”) stored at entry R_{S,W} for the situation where point (t_{r(N-1)}, C_{l(N-1)}) forms the upper right corner of subregion 2 of FIG. 10;

(c) the error (“subregion 3 error”) stored at entry R_{X,W} for the situation where point (t_{r(S)}, C_{l(N-1)}) forms the upper right corner of subregion 3 of FIG. 10; and

(d) the error (“subregion 4 error”) stored at entry R_{S,Y} for the situation where point (t_{r(N-1)}, C_{l(W)}) forms the upper right corner of subregion 4 of FIG. 10.

With regard to the error determined as a result of such addition, such error is the 2-stage error resulting from selection of candidate point (t_{r(X)}, C_{l(Y)}) “in combination with point (t_{r(S)}, C_{l(W)}) as an intermediate point to point (t_{r(N-1)}, C_{l(N-1)}).”

For each candidate point (t_{r(X)}, C_{l(Y)}), system 100 determines such a 2-stage error for all integer values of S and W, where X<S<(N−1), and where Y<W<(N−1). Moreover, for each candidate point (t_{r(X)}, C_{l(Y)}), system 100 determines the intermediate point (t_{r(S)}, C_{l(W)}) for which the 2-stage error is smallest. Accordingly, at entry R_{X,Y} (of table 950) associated with candidate point (t_{r(X)}, C_{l(Y)}), system 100 stores an indication of the point (t_{r(S)}, C_{l(W)}) for which the 2-stage error is smallest, along with the value of that smallest 2-stage error.

In addition, system 100 stores or tracks a value that represents the total number of Taylor's series or Maclaurin series coefficients or terms that is uses as it combines subregions. (Note that system 100 also stores the coefficients or terms along with the total number of coefficients or terms.) As noted above, by using all the available data points, system 100 can reduce the error to zero. Using all the available data points, however, results in a relatively large number of coefficients. By storing the total number of coefficients or terms, system 100 can provide a metric, measure, or figure of merit that helps to determine which Taylor's series or Maclaurin series to combine. The system 100 can provide the metric by using the total number of coefficients or terms, along with other optimization criteria, such as total amount of memory or storage used, as desired. The user 112 may specify or prescribe an upper limit for the number of coefficients or terms used, as desired. System 100 may use that upper limit to combine subregions.

Furthermore, depending on parameters supplied by user 112 (e.g., the number of Taylor's or Maclaurin series and/or the number of terms or coefficients in the Taylor's or Maclaurin series), system 100 may use an iterative approach. System 100 may first employ a Taylor's series or Maclaurin series expansion that includes linear terms (i.e., no quadratic or cubic, etc., terms). Depending on the error measure or measures resulting from using such a series expansion, system 100 may next employ a Taylor's series or Maclaurin series expansion that includes both linear and quadratic terms. Next, depending on the error measure or measures from using that series expansion, system 100 may iterate the process a Taylor's series or Maclaurin series expansion that uses terms with increasing powers (e.g., cubic terms, etc.) until the resulting error measure or measures satisfy the criteria that user 112 has prescribed.

Note that the above process may constitute an interactive process, as desired. In other words, during each iteration, system 100 may present the results (e.g., the Taylor's or Maclaurin series and the error measure or measures) to user 112. Note that system 100 may optionally present the results from previous iterations to user 112, as desired. User 112 may then decide whether to instruct system 100 to use Taylor's or Maclaurin series expansions with higher-powered terms. Thus, rather than, or in addition to, providing prescribed parameters to system 100, user 112 may interactively examine the results of each iteration and/or direct system 100 to use the current or a previous Taylor's or Maclaurin series expansion, or to try a higher-powered expansion.

FIG. 11 is an illustration of a second multi-stage version of the technique discussed hereinabove in connection with FIG. 10. In FIG. 11, entry 1202 is R_{X,Y} associated with point (t_{r(X)}, C_{l(Y)}) of FIG. 10. For determining a 3-stage error resulting from selection of a candidate point (t_{r(A)}, C_{l(B)}), where A<X and/or B<Y, system 100 adds the smallest 2-stage error of FIG. 10 (i.e., the 2-stage error stored by system 100 at entry R_{X,Y}) to (a) a “subregion 1 error” of FIG. 11, (b) a “subregion 3 error” of FIG. 11, (c) a “subregion 4 error” of FIG. 11, (d) a “subregion 5 error” of FIG. 11, and (d) a “subregion 6 error” of FIG. 11. System 100 performs such addition of the subregion 1, 3, 4, 5 and 6 errors of FIG. 11 in a manner analogous to the manner in which system 100 performs addition of the regions 1, 2, 3 and 4 errors of FIG. 10 as discussed further hereinabove.

For each candidate point (t_{r(X)}, C_{l(Y)}), system 100 determines such a 3-stage error for all possible combinations of 2 intermediate points between point (t_{r(X)}, C_{l(Y)}) and point (t_{r(N-1)}, C_{l(N-1)}). Moreover, for each candidate point (t_{r(X)}, C_{l(Y)}), system 100 determines the 2 intermediate points for which the 3-stage error is smallest. Accordingly, at entry R_{X,Y} (of table 950) associated with candidate point (t_{r(X)}, C_{l(Y)}), system 100 stores an indication of the 2 intermediate points for which the 3-stage error is smallest, along with the value of that smallest 3-stage error.

Likewise, where (c+2)² is a number of characterization points to be selected by system 100 (including the four corner points discussed further hereinabove in connection with FIG. 8), system 100 determines (for corner point (tᵣ₍₀₎, Cₗ₍₀₎)) a (c+1)-stage error for all possible combinations of c intermediate points between corner point (tᵣ₍₀₎, Cₗ₍₀₎) and corner point (t_{r(N-1)}, C_{l(N-1)}). Moreover, for corner point (tᵣ₍₀₎, Cₗ₍₀₎), system 100 determines the c intermediate points for which the (c+1)-stage error is smallest. Accordingly, at entry R_{0,0} (of table 950) associated with corner point (tᵣ₍₀₎, Cₗ₍₀₎), system 100 stores an indication of the c intermediate points for which the (c+1)-stage error is smallest, along with the value of that smallest (c+1)-stage error.

As noted above, in addition, system 100 stores or tracks a value that represents the total number of Taylor's series or Maclaurin series coefficients or terms that is uses as it combines subregions (along with the coefficients or terms themselves). Also as noted above, system 100 may provide a metric, measure, or figure of merit that helps to determine which Taylor's series or Maclaurin series to combine based on the total number of coefficients or terms and other optimization criteria, such as total amount of memory or storage used, as desired. The user 112 may specify or prescribe an upper limit for the number of coefficients or terms used, as desired, which the system 100 may use to combine subregions.

Furthermore, rather than selecting Taylor's or Maclaurin series expansion or expansions based on error alone, system 100 may use additional parameters. For example, system 100 may use the error together with the total number of Taylor's or Maclaurin series coefficients or terms to decide which expansion or expansions to use. Put another way, the error and the total number of coefficients or terms form a figure of merit that system 100 may use. Note that, rather than system 100 making the selection, user 112 may do so interactively after system 100 has presented the relevant data and results to user 112.

In addition to, or instead of, the total number of coefficients or terms, system 100 may use (or user 112 may prescribe system 100 to use) other parameters, such as processing time, the available memory or processing resources available, etc. The choice of parameters or figures-of-merit depends on the performance and specifications for each application, as persons of ordinary skill in the art who have the benefit of the description of the invention understand.

Regardless of which of the parameters, metrics, or figures-of-merits described above system 100 and/or user 112 use, user 112 may specify prescribed limits on the parameters, metrics, or figures-of-merit. System 100 (or system 100 and user 112 interactively) may use the prescribed limits to select Taylor's or Maclaurin series expansion or expansions.

By selecting the c intermediate points as characterization points, system 100 selects (c+2)² characterization points (including the corner points discussed further hereinabove in connection with FIG. 8). For example, referring to FIG. 11, by selecting three intermediate points (t_{r(A)}, C_{l(B)}) associated with entries 1102, 1202 and 1204, system 100 selects (3+2)²=25 characterization points, namely (a) the three intermediate points (t_{r(A)}, C_{l(B)}) associated with entries 1102, 1202 and 1204, (b) the four corner points (tᵣ₍₀₎, Cₗ₍₀₎), (tᵣ₍₀₎, C_{l(N-1)}), (t_{r(N-1)}, C_{l(N-1)}) and (t_{r(N-1)}, Cₗ₍₀₎) associated with entries 1206, 1208, 1210 and 1212, respectively, (c) the side points (t_{r(A)}, C_{l(B)}) associated with entries 1214, 1216, 1218, 1220, 1222, 1224, 1226, 1228, 1230, 1232, 1234 and 1236, and (d) the interior points (t_{r(A)}, C_{l(B)}) associated with entries 1238, 1240, 1242, 1244, 1246 and 1248.

Note that, in addition to minimizing the error as described above, the system 100 may trade off error for space complexity (i.e., use of computer storage, such as computer memory) of the calculations. To reduce space complexity, the system 100 may use Taylor's series with smaller degrees and, hence, fewer coefficients to store. Based on input from user 112, the system 100 may seek to: (a) reduce both space complexity and error; (b) reduce space complexity; or (c) reduce error. The system 100 may use heuristics to accomplish that task, as desired. Furthermore, the system 100 may allow the user 112 to specify a minimum degree or a maximum degree for the Taylor's series expansions, as desired. Other than the examples given here, one may configure the system 100 to provide a wide variety of performance criteria. In this manner, the system 100 provides flexibility to the user of trading off characterization error and computer storage/memory. Moreover, note that, as desired, one may apply the characteristic equation in the form of Taylor's or Maclaurin series expansions to multi-dimensional characteristic equations that represent a cell's operation(s) in response to (or “as a function of”) various types and ranges of conditions (as described above).

FIG. 12 is a graph, indicated generally at 1200, of average percentage error as a function of Cₗ and tᵣ, where characterization points were manually selected (after several iterations) by a human without the techniques of exemplary embodiments of the invention. In connection with FIG. 12, for each measured point (t_{r(A)}, C_{l(B)}), system 100:

(a) determined a respective value of r (rᵢₙₜₑᵣₚₒₗₐₜₑ) in response to the particular values of tᵣ and Cₗ which define such measured point, in accordance with the technique discussed further hereinabove in connection with FIG. 7;

(b) executed SPICE for determining a respective value of r (r_{SPICE}) in response to the particular values of tᵣ and Cₗ which define such measured point; and

(c) determined the percentage error between rᵢₙₜₑᵣₚₒₗₐₜₑ and r_{SPICE}

Such percentage errors are graphically illustrated on graph 1200 as a function of Cₗ and tᵣ. As shown in FIG. 12, the largest errors occur for smaller values of Cₗ and tᵣ. This is a shortcoming, because cells in critical timing paths are most likely to have smaller values of Cₗ and tᵣ.

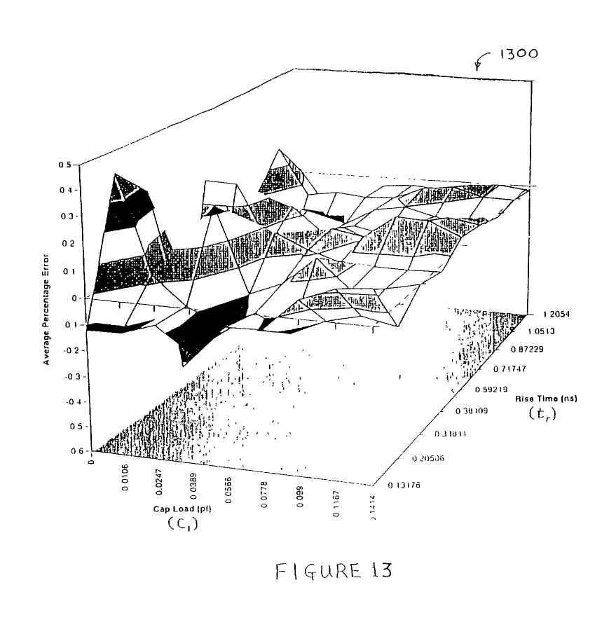

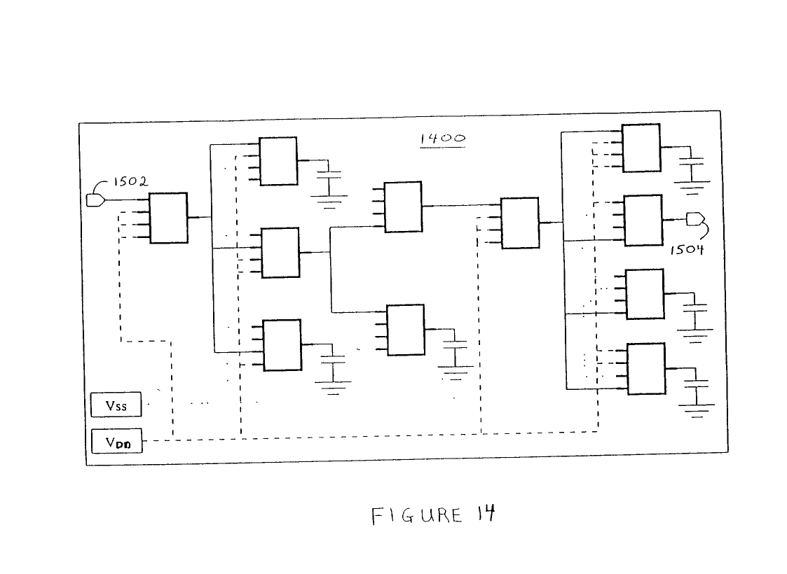

FIG. 13 is a graph, indicated generally at 1300, of average percentage error as a function of Cₗ and tᵣ, where characterization points were automatically selected by system 100 in accordance with the technique of an illustrative embodiment according to the invention that uses a characteristic equation given by equation (1). In connection with FIG. 13, system 100 determined the percentage errors in the same manner as discussed further hereinabove in connection with FIG. 12. As shown in FIG. 13, the errors are primarily limited to ±0.2%, which is substantially improved over the errors shown in FIG. 12.

In connection with FIG. 13, table 950 (FIG. 9) occupied 3.125 million double-word values, or approximately 25 Mb, of memory within system 100. Within approximately 17 CPU (central processing unit) minutes, system 100 selected c=8 intermediate characterization points between corner point (tᵣ₍₀₎, Cₗ₍₀₎) and corner point (t_{r(N-1)}, C_{l(N-1)}). System 100 used approximately 16 of the 17 CPU minutes to perform the steps discussed further hereinabove in connection with FIG. 9. In another example, system 100 selected c=6 intermediate characterization points between corner point (tᵣ₍₀₎, Cₗ₍₀₎) and corner point (t_{r(N-1), C}_{l(N-1)}), within only approximately 9 CPU minutes.

In yet another example, where characterization points were automatically selected by system 100 in accordance with the technique of the alternative embodiment discussed further hereinabove in connection with FIG. 11, the percentage errors were up to three times (3×) higher than errors shown in FIG. 13. Advantageously, however, system 100 selected c=8 intermediate characterization points between corner point (tᵣ₍₀₎, Cₗ₍₀₎) and corner point (t_{r(N-1)}, C_{l(N-1)}) within only approximately 5 CPU seconds, and table 950 (FIG. 9) occupied less than 100 Kb of memory within system 100. Moreover, the errors were primarily limited to +0.5% through −0.8%, which is still substantially improved over the errors shown in FIG. 12.

FIG. 14 is a schematic electrical circuit diagram of circuitry 1400, including a biased path, created according to an illustrative embodiment of the invention. System 100 has characterized a standard cell library in accordance with the technique of the illustrative embodiment. The library included almost 2000 standard cells. With components from the library, system 100 creates (or “synthesizes”) a design of circuitry (e.g., circuitry 1400).

For verifying accuracy of the characterization, system 100 executes the Synopsys static timing analysis software package to identify critical timing paths within the design. More particularly, system 100 identifies components along a critical timing path, plus any secondary components. As shown in FIG. 14, according to a technique referred to as tertiary loading, output nodes of secondary components are connected to respective capacitors having capacitive values substantially matched to respective loads driven by such nodes. Also, as shown in FIG. 14, with regard to nodes outside the critical timing path and apart from secondary components, such nodes are biased to V_{DD} or V_{SS} for the purpose of propagating the signal from an input node 1502 to an output node 1504.

After identifying the critical timing path, performing tertiary loading of output nodes of secondary components, and biasing nodes outside the critical timing path and apart from secondary components: system 100 executes SPICE in response to such information, and system 100 measures results therefrom at input nodes and output nodes of cells within the design. Such results are tᵢₙ, tₒᵤₜ and t_{d} as discussed further hereinabove in connection with FIG. 4. System 100 is able to compare such results against measurements from the Synopsys static timing analysis software package (executed by system 100).

System 100 has performed such verification for over 200 different critical timing paths that include cells characterized according to an illustrative embodiment of the invention that uses the characteristic equation given by equation (1). Over 98% of the paths had cumulative path delays (e.g., cumulative path delay between input node 1502 and output node 1504) with error margins less than 2% to 4%. Accordingly, the static timing delays measured from the Synopsys static timing analysis software package (executed by system 100) were usually 2% to 4% greater than those measured from SPICE (executed by system 100).

In exemplary embodiments, the characterization technique of system 100 may be implemented on a UNIX operating system using a C++ programming language. Also, in an illustrative embodiment that uses the characteristic equation given by equation (1), system 100 performs solution of equation (1) by LU decomposition and forward and backward substitution. The version of SPICE in exemplary embodiments may be HSPICE, commercially available from Synopsys, Inc., 700 East Middlefield Road, Mountain View, Calif. 94043, telephone number (650) 584-5000 or (800) 541-7737, although one may use other appropriate simulation engines, for example, other types or versions of SPICE, as persons of ordinary skill in the art who have the benefit of the description of the invention understand.

Although illustrative and exemplary embodiments and their advantages have been described in detail hereinabove, they have been described as examples and not as limitations. Various changes, substitutions and alterations can be made to the exemplary embodiments without departing from the breadth, scope and spirit of the claims. Such modifications and alternative embodiments of the invention will be apparent to persons skilled in the art who have the benefit of the description of the invention. Accordingly, this description teaches those skilled in the art the manner of carrying out the invention and are to be construed as illustrative only, and not as limiting.

The forms of the invention shown and described should be taken as the presently preferred embodiments. Persons skilled in the art may make various changes in the shape, size and arrangement of parts and steps without departing from the scope of the invention described here. For example, persons skilled in the art may substitute equivalent elements for the elements or steps illustrated and described here. Moreover, persons skilled in the art who have the benefit of this description of the invention may use certain features of the invention independently of the use of other features, without departing from the scope of the invention.

1. A system, comprising:
a computer for:
according to a first model of an operation of circuitry, generating a first set of estimates of the operation in response to a set of conditions, including a first estimate of the operation in response to a first condition;
according to a second model of the operation, generating a second set of estimates of the operation in response to the first condition and the first set;
in response to a comparison between the first estimate and the second set, selecting a subset of the first set; and
according to the second model, generating an estimate of the operation in response to a second condition and the selected subset,
wherein the second model of the operation comprises a series expansion characteristic equation.

2. The system of claim 1 wherein the series expansion characteristics equation comprises a Taylor's series expansion characteristic equation or a Maclaurin series expansion characteristic equation.

3. The system of claim 1 wherein the first model includes a circuit simulator.

4. The system of claim 2 wherein the series expansion characteristics equation comprises a multi-variable characteristic equation.

5. The system of claim 3 wherein the second model is a static timing analysis model including the characteristic equation.

6. The system of claim 3 wherein the computer is for generating the second set by:
determining respective sets of constant elements of the characteristic equation in response to subsets of the first set; and
according to the characteristic equation, in response to the first condition, generating the second set including respective estimates of the operation in response to the sets of constant elements.

7. The system of claim 6 wherein a user prescribes the degree of the characteristic equation.

8. The system of claim 7 wherein the user prescribes the subsets of the first set.

9. The system of claim 2 wherein the operation is a response time of the circuitry.

10. The system of claim 2 wherein the operation is a propagation delay of the circuitry.

11. The system of claim 2 wherein the operation is power dissipation of the circuitry.

12. The system of claim 2 wherein the conditions include capacitive loadings of the circuitry.

13. The system of claim 2 wherein the conditions include input transition times of the circuitry.

14. The system of claim 2 wherein the conditions include operating temperature of the circuitry.

15. The system of claim 2 wherein the circuitry is integrated circuitry.

16. A method, comprising:
with a first computer-implemented model of an operation of circuitry, generating a first set of estimates of the operation in response to a set of conditions, including a first estimate of the operation in response to a first condition;
with a second computer-implemented model of the operation, generating a second set of estimates of the operation in response to the first condition and the first set;
in response to a comparison between the first estimate and the second set, selecting a subset of the first set; and
with the second computer-implemented model, generating an estimate of the operation in response to a second condition and the selected subset,
wherein the second model of the operation comprises a series expansion characteristic equation.

17. The method of claim 16 wherein the series expansion characteristics equation comprises a Taylor's series expansion characteristic equation or a Maclaurin series expansion characteristic equation.

18. The method of claim 16 wherein the first model includes a circuit simulator.

19. The method of claim 17 wherein the series expansion characteristics equation comprises a multi-variable characteristic equation.

20. The method of claim 18 wherein the second model is a static timing analysis model including the characteristic equation.

21. The method of claim 18 wherein the computer is for generating the second set by:
determining respective sets of constant elements of the characteristic equation in response to subsets of the first set; and
according to the characteristic equation, in response to the first condition, generating the second set including respective estimates of the operation in response to the sets of constant elements.

22. The method of claim 21 wherein a user prescribes the degree of the characteristic equation.

23. The method of claim 22 wherein the user prescribes the subsets of the first set.

24. The method of claim 17 wherein the operation is a response time of the circuitry.

25. The method of claim 17 wherein the operation is a propagation delay of the circuitry.

26. The method of claim 17 wherein the operation is power dissipation of the circuitry.

27. The method of claim 17 wherein the conditions include capacitive loadings of the circuitry.

28. The method of claim 17 wherein the conditions include input transition times of the circuitry.

29. The method of claim 17 wherein the conditions include operating temperature of the circuitry.

30. The method of claim 17 wherein the circuitry is integrated circuitry.

31. A computer program product, comprising:
a computer application processable by a computer for causing the computer to:
according to a first model of an operation of circuitry, generate a first set of estimates of the operation in response to a set of conditions, including a first estimate of the operation in response to a first condition;
according to a second model of the operation, generate a second set of estimates of the operation in response to the first condition and the first set;
in response to a comparison between the first estimate and the second set, select a subset of the first set; and
according to the second model, generate an estimate of the operation in response to a second condition and the selected subset; and
apparatus from which the computer application is accessible by the computer, wherein the second model of the operation comprises a series expansion characteristic equation.

32. The computer program product of claim 31 wherein the series expansion characteristics equation comprises a Taylor's series expansion characteristic equation or a Maclaurin series expansion characteristic equation.

33. The computer program product of claim 31 wherein the first model includes a circuit simulator.

34. The computer program product of claim 32 wherein the series expansion characteristics equation comprises a multi-variable characteristic equation.

35. The computer program product of claim 33 wherein the second model is a static timing analysis model including the characteristic equation.

36. The computer program product of claim 33 the computer application is processable by the computer for causing the computer to generate the second set by:
determining respective sets of constant elements of the characteristic equation in response to subsets of the first set; and
according to the characteristic equation, in response to the first condition, generating the second set including respective estimates of the operation in response to the sets of constant elements.

37. The computer program product of claim 36 wherein a user prescribes the degree of the characteristic equation.

38. The computer program product of claim 37 wherein the user prescribes the subsets of the first set.

39. The computer program product of claim 32 wherein the operation is a response time of the circuitry.

40. The computer program product of claim 32 wherein the operation is a propagation delay of the circuitry.

41. The computer program product of claim 32 wherein the operation is power dissipation of the circuitry.

42. The computer program product of claim 32 wherein the conditions include capacitive loadings of the circuitry.

43. The computer program product of claim 32 wherein the conditions include input transition times of the circuitry.

44. The computer program product of claim 32 wherein the conditions include operating temperature of the circuitry.

45. The computer program product of claim 32 wherein the circuitry is integrated circuitry.
